(19) United States
(12) Patent Application Publication
(10) Pub. No.: US 2022/0398316 A1
(43) Pub. Date: Dec. 15, 2022

(54) ARTIFICIAL INTELLIGENCE DETECTION OF RANSOMWARE ACTIVITY PATTERNS ON COMPUTER SYSTEMS

(71) Applicant: BANK OF AMERICA CORPORATION, Charlotte, NC (US)

(72) Inventors: Tomas M. Castrejon, III, Fort Mill, SC (US); David Nardoni, Sierra Madre, CA (US); Bradley P. Welch, Fort Mill, SC (US)

(73) Assignee: BANK OF AMERICA CORPORATION, Charlotte, NC (US)

(21) Appl. No.: 17/837,196

(22) Filed: Jun. 10, 2022

Related U.S. Application Data
(60) Provisional application No. 63/209,488, filed on Jun. 11, 2021.

(51) Int. Cl. G06F 21/56; G06F 21/55

(52) U.S. Cl. CPC G06F 21/566; G06F 21/552; G06F 2221/034

(57) ABSTRACT

Artificial Intelligence (AI)-based detection of malware, and, specifically, ransomware, based on observing behaviors that occur in the computing system in the presence of the malware and training the AI to monitor for such behaviors. Once the behaviors are detected, they are compared to acceptable baseline level of occurrence of the behaviors (i.e., normal computing system behaviors) and if determined to exceed the baseline level, one or more actions are triggered to mitigate or prevent the malware/ransomware attack. By basing the detection of malware on behaviors, such as computing system events and/or configurations, as opposed to solely based on indicators (e.g., digital signatures), the ability of wrongdoers circumventing the detection mechanisms is lessened and the likelihood that malware is detected prior to detonation greatly increases.

### CROSS-REFERENCE TO RELATED APPLICATIONS

This application is a U.S. Non-provisional application claiming priority to U.S. Provisional Patent Application No. 63/209,488 filed Jun. 11, 2021, titled Artificial Intelligence Detection of Ransomware Activity Patterns on Computer Systems, the contents of which are hereby incorporated by reference in its entirety.

### FIELD OF THE INVENTION

The present invention is generally directed to computing system security and, more specifically, implementing artificial intelligence (AI) to detect the onset of malware activity patterns/behaviors and, in response, take appropriate actions to mitigate or prevent a malware attack.

### BACKGROUND

Malware software is specifically designed to disrupt, damage, or gain unauthorized access to a computer system. Wrongdoers gain access to a computer network and install the malware on a computing system. Once the malware is executed (i.e., detonated) it performs a designated nefarious action, such as, misappropriate information, for example, user credentials, user passwords or the like. Other forms of malware provide for backdoor access to computing systems, such that normal authentication is no longer required to access the system and, as a result the wrongdoer can remotely access resources within an application, such as databases, file servers or the like, providing the wrongdoers the ability to remotely issue system commands.

One specific type of malware that is becoming increasingly prevalent is ransomware. Ransomware uses a technique called cryptoviral extortion, in that, the software encrypts the victim's files, making them inaccessible, and demands a ransom payment, typically in the form of digital currencies, in order to decrypt the files. From the enterprise perspective, not only are ransomware attacks costly in terms of the ransom payment, they also result in other impacts to the enterprise, such as loss of production, negative exposure and the like.

Current defense mechanisms to prevent malware attacks and, specifically, ransomware attacks have proven to be less than desirable. Typically, antivirus software or the like is implemented as the means by which entities attempt to prevent malware attacks. Most antivirus software is designed to look for specific indicators, such as specific digital signatures of known malware software and, in response to detecting a digital signature, take appropriate action, such as communicating alerts, isolating computing systems/devices or the like. However, the wrongdoers, well aware of how antivirus software operates, will frequently change the digital signatures of their malware software. Such changes in digital signatures may occur on a day-by-day basis or, in some instances, more frequently, such as, an hour-by-hour basis. Unfortunately, the updating of known digital signatures within the antivirus software tends to lag behind the frequency by which the digital signatures change. In this regard, if the antivirus software has not been updated to detect a new digital signature, malware having the new digital signature will go undetected and attacks will occur.

In addition to digital signatures, current malware prevention software may be designed to look for other indicators, such as the presence of certain files in certain directory structure or the indication that certain files have been manipulated. However, not unlike the detection of digital signatures, the detection if these other indicators tends to be a reactive means of defense, in that, the malware software is likely to have already been installed in the system and, in some instances, may already be executing or execution is imminent. In the case of ransomware, once the encryption process has begun, it is likely too late to prevent the files from becoming inaccessible.

Therefore, a need exists to develop systems, methods, computer program products and the like which are capable of detecting the onset of malware, specifically ransomware, activity, such that preventive actions can be taken prior to the execution/detonation of the malware/ransomware on the computing system. In this regard, the desired systems, methods, computer program products should not solely rely on the detection of digital signatures or other specific indicators, which have proven to be ineffective for the reasons discussed above.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for Artificial Intelligence (AI) detection of malware, and, in specific embodiments, ransomware, based on behaviors that occur in the computing system in the presence of the malware. In this regard, according to the present invention, malware detection is not based on, or in some embodiments is not limited to, detection of indicators (e.g., digital signatures or the like) that indicate the presence of malware. As previously discussed, malware detection based solely on indicators may not be effective due to the inability of the virus protection software to detect ever changing indicators (i.e., ever changing digital signatures) and/or the inability to detect a malware attack prior to detonation of the virus.

Specifically, the present invention determines, or otherwise observes, the behaviors that occur within the computing system in the presence of malware software. These determinations may be made by observing actual malware attacks in the computing system and/or, in other embodiments, conducting hypothetical malware attacks in a controlled computing environment. The behaviors, otherwise referred to as computing activities may include any computing event or computing system configuration that occurs in the presence of malware software. In specific embodiments of the invention, the behaviors that are determined are a pattern of behaviors (i.e., two or more behaviors occurring simultaneously or in sequence). For specific embodiments of the invention, in which the malware is ransomware, the behaviors may include any computing event, system configuration or pattern of computing events/system configurations that occur prior to the encryption of files.

In response to determining the behaviors, Artificial Intelligence (AI) algorithms, which may in some embodiments include Machine Learning (ML) are trained to monitor for the occurrence of the behaviors and, in response to detecting an occurrence of a behavior and determining that the occurrence of the behavior exceeds an acceptable baseline level of occurrence, perform one or more actions that mitigate or eliminate the malware threats. Once trained, the AI algorithms, are executed to monitor for the behaviors and/or pattern of behaviors, and, in response to detecting the behaviors or pattern of behaviors and determining that the behavior level exceeds an acceptable baseline level of occurrence, one or more actions are triggered to mitigate (i.e., prohibit further propagation of the malware within the computing network) or eliminate (i.e., stop the malware from detonating within the computing system) the threat posed by the malware.

In specific embodiments of the invention, the actions that are triggered (e.g., communication of alerts, isolation of computing systems, or the like) are determined, by the AI/ML, on-the-fly based on rules that take into account the attributes of the behaviors (type of behaviors, volume of behaviors, timing of behaviors and the like).

Moreover, in additional embodiments of the invention, AI algorithms are trained not only to detect behaviors and/or patterns of behaviors but also other known or future known indicators (e.g., digital signatures or the like), which indicate the presence of malware in the system.

Thus, embodiments of the present invention provide for robust and highly efficient means for detecting malware, and, specifically, ransomware, within a computing system. By creating a system that leverages AI/ML to train for detection of observed behaviors that occur in the presence of malware, the present invention is not susceptible to wrongdoer circumvention and is more likely to detect the presence of malware before detonation or limit/isolate the harm caused by malware in the event detonation has already occurred.

A system for detection and prevention of threats posed by malware software on computing system, defines first embodiments of the invention. The system includes a first computing platform having a first memory and one or more first processing devices in communication with the first memory. The first memory stores instructions that are executable by the one or more first processing devices. The instructions and configured to determine one or more behaviors of a computing system that occur in a presence of malware software. The instructions are further configured to train, one or more Artificial Intelligence (AI) algorithms, to (i) monitor for the behaviors within a specified computing system, and (ii) in response to detecting at one or more of the behaviors and determining that the one or more of the behaviors exceeds an acceptable baseline level for the one or more behaviors, perform one or more actions to mitigate or eliminate a threat posed by the malware software.

The system additionally includes a second computing platform having a second memory and one or more second processing devices in communication with the first memory. The second memory stores the trained one or more AI algorithms that are executable by the one or more processing devices. The trained AI algorithms are configured to monitor for the behaviors within the specified computing system, and in response to detecting the one or more of the behaviors and determining that the at least one of the one or more behaviors exceeds the acceptable baseline level for the corresponding behavior, perform one or more actions to mitigate or eliminate the threat posed by the malware software.

In specific embodiments the system is operating system-agnostic, which means that the system can be utilized in any operating system environment, including, but limited to, Microsoft WINDOWS®, Apple macOS®, LINUX®/Open source-based and the like.

In other specific embodiments of the system, the malware software is further defined as ransomware software. In such embodiments of the system, the instructions configured to determine the one or more behaviors of the computing system that occur in the presence of the malware software, further defines the behaviors as events or configurations in the computing system that occur in preparation for self-encryption of files (i.e., prior to the actual encryption of files).

In still further specific embodiments of the system, the behaviors are defined as one or more of (i) disk input/output calls, (ii) memory utilization, (iii) central or graphics processing unit utilization, (iv) files accessed, (v) types of calls made to the operating system, (vi) ports and protocols used for calls, (vii) attempts to escalate access privileges, and the like.

In additional specific embodiments of the system, the one or more behaviors of the computing system are a pattern of behaviors, such that, the instructions configured to train, the AI algorithms, to monitor for the behaviors are further configured to train, the one or more AI algorithms, to monitor for the pattern of behaviors and, take action actions in response to detecting the pattern.

In other specific embodiments of the system, the instructions configured to determine the one or more behaviors of the computing system that occur in the presence of the malware software are further configured implementing Artificial Intelligence (AI) and Machine Learning (ML), to determine the one or more behaviors of the computing system that occur in the presence of the malware software. In this regard, the behaviors may be determined by observing behavior that occur when actual or simulated malware attacks occur within the specified computing system.

Additionally, in other specific embodiments of the system, the AI algorithms are further configured to determine the one or more actions based on applying one or more rules to the detected behavior.

In still further specific embodiments of the system, the first instructions are further configured to train, the one or more AI algorithms, to further monitor for one or more predetermined indicators (e.g., digital signatures or the like) that indicate the presence of the malware software. In such embodiments of the system, the one or more actions are configured to be performed in response to detection of not only one or more behaviors but also at least one of the one or more predetermined indicators.

Moreover, in other specific embodiments of the system, the instructions configured to determine one or more behaviors are further configured to analyze, using Machine Learning (ML), the one or more behaviors based on changes to at least one of (i) hardware and/or software configuration within the computing system, (ii) service packs installed on the computing system, (iii) operating system revisions and the like.

A computer-implemented method for detection and prevention of threats posed by malware software on computing system defines second embodiments of the invention. The computer-implemented method is executable by one or more computing processor devices. The method includes determining one or more behaviors of a computing system that occur in a presence of malware software and training, one or more Artificial Intelligence (AI) algorithms, to (i) monitor for the behaviors within a specified computing system, and (ii) in response to detecting at least one of the behaviors and determining that the at least one of the behaviors exceeds an acceptable baseline level for the corresponding behavior, perform one or more actions to mitigate or eliminate a threat posed by the malware software. The method further includes monitoring, by the one or more AL algorithms, for the behaviors within the specified computing system, and, in response to detecting at least one of the behaviors and determining that the at least one of the behaviors exceeds the acceptable baseline level for the corresponding behavior, performing, by the one or more AI algorithms, one or more actions to mitigate or eliminate the threat posed by the malware software.

In specific embodiments the method is operating system-agnostic, which means that is can be performed within any known or future known operating system environment. In other specific embodiments of the method, the malware software is further defined as ransomware software. In such embodiments of the method, the behaviors that are determined are defined as computing events or configurations that occur in preparation for self-encryption of files.

In still further specific embodiments of the method, the behaviors that are determined include one or more of (i) disk input/output calls, (ii) memory utilization, (iii) processing unit utilization, (iv) files accessed, (v) types of calls made to operating system, (vi) ports and protocols used for calls, (vii) attempts to escalate access privileges, and the like. Moreover, in additional specific embodiments of the method, the one or more behaviors that are determined are a pattern of behaviors, such that training, the one or more AI algorithms, to monitor for the behaviors further includes training, the one or more AI algorithms, to monitor for the pattern of behaviors, such that the actions occur in response to the pattern of events. A computer program product comprising a non-transitory computer-readable medium defines third embodiments of the invention. The computer-readable medium includes a first set of codes for causing a computer to determine one or more behaviors of a computing system that occur in a presence of malware software. The computer-readable medium additionally includes a second set of codes for causing a computer to train, one or more Artificial Intelligence (AI) algorithms, to (i) monitor for the behaviors within a specified computing system, and (ii) in response to detecting at least one of the behaviors and determining that the at least one of the behaviors exceeds an acceptable baseline level for the at least one of the behaviors, perform one or more actions to mitigate or eliminate a threat posed by the malware software. Further, the computer-readable medium includes a third set of codes for causing a computer to monitor, by the one or more AL algorithms, for the behaviors within the specified computing system, and a fourth set of codes for causing a computer to, in response to detecting at least one of the behaviors and determining that the at least one of the behaviors exceeds the acceptable baseline level for the at least one of the behaviors, perform, by the one or more AI algorithms, one or more actions to mitigate or eliminate the threat posed by the malware software.

In specific embodiments of the computer program product, the sets of codes are operating system-agnostic, meaning that are configured to be implemented within any known or future known operating system.

In other specific embodiments of the computer program product, the malware software is further defined as ransomware software and, in such embodiments, the behaviors are defined as computing events that occur in preparation for self-encryption of files.

In still further specific embodiments of the computer program product, the one or more behaviors are further defined as one or more of (i) disk input/output calls, (ii) memory utilization, (iii) processing unit utilization, (iv) files accessed, (v) types set of codes of calls made to operating system, (vi) ports and protocols used for calls, (vii) attempts to escalate access privileges and the like.

In other specific embodiments of the computer program product, the first set of codes is further configured to cause the computer to determine a pattern of behaviors that occur in the presence of the malware software and the second set of codes are further configured to cause the computer to train, the one or more AI algorithms, to monitor for the pattern of behaviors, such that, the actions occurred in response to detecting the pattern of behaviors.

Thus, according to embodiments of the invention, which will be discussed in greater detail below, the present invention provides for needs and/or achieves other advantages by providing for Artificial Intelligence (AI) detection of malware, and, specifically, ransomware, based on behaviors that occur in the computing system in the presence of the malware. In this regard, according to the present invention, malware detection is not based on, or in some embodiments is not limited to, detection of indicators (e.g., digital signatures or the like) that indicate the presence of malware. The invention observes/determines behavior or patterns or behaviors that occur in the computing system in the presence of malware and, in response, trains the AI to monitor for such behaviors and, in response to detecting a behavior(s) and determining that the occurrence exceeds a baseline level of occurrence, the AI initiates performance of one or more actions to mitigate or eliminate the malware threat.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a system for AI-based detection malware behaviors to mitigate or prevent malware/ransomware attacks on computing system, in accordance with embodiments of the present invention;

FIG. 2 is a block diagram of a first computing platform configured for observing/determining behaviors in computing system in the presence of malware/ransomware and training AI to monitor for the behaviors and, in response to detecting behaviors that exceed a normal baseline level, initiate actions to mitigate or prevent a malware/ransomware attack, in accordance with embodiments of the present invention; and

FIG. 3 is a flow diagram of a method for AI-based detection malware behaviors to mitigate or prevent malware/ransomware attacks on computing system, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as JAVA, PERL, SMALLTALK, C++, PYTHON, or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

“Computing platform” or “computing device” as used herein refers to a networked computing device within the computing system. The computing platform may include a processor, a non-transitory storage medium (i.e., memory), a communications device, and a display. The computing platform may be configured to support user logins and inputs from any combination of similar or disparate devices. Accordingly, the computing platform includes servers, personal desktop computer, laptop computers, mobile computing devices and the like.

Thus, systems, apparatus, and methods are described in detail below that provide for Artificial Intelligence (AI), including Machine Learning (ML), detection of malware, and, in specific embodiments, ransomware, based on behaviors that occur in the computing system in the presence of the malware. In this regard, according to the present invention, malware detection is not based on, or in some embodiments is not limited to, detection of indicators (e.g., digital signatures or the like) that indicate the presence of malware. As previously discussed, malware detection based solely on indicators may not be effective due to the inability of the virus protection software to detect ever changing indicators/digital signatures and/or the inability to detect a malware attack prior to detonation of the virus.

Specifically, the present invention determines, or otherwise observes, the behaviors that occur within the computing system in the presence of malware software. These determinations may be made by observing actual malware attacks in the computing system and/or, in other embodiments, conducting hypothetical malware attacks in a controlled computing environment. The behaviors, otherwise referred to as computing activities, may include any computing event or computing system configuration that occurs in the presence of malware software. In specific embodiments of the invention, the behaviors that are determined are a pattern of behaviors (i.e., two or more behaviors occurring simultaneously or in sequence). For specific embodiments of the invention, in which the malware is ransomware, the behaviors may include any computing event, system configuration or pattern of computing events/system configurations that occur prior to the encryption of files.

In response to determining the behaviors, Artificial Intelligence (AI) algorithms, which may in some embodiments include Machine Learning (ML), are trained to monitor for the occurrence of the behaviors and, in response to detecting an occurrence of a behavior and determining that the occurrence of the behavior exceeds an acceptable baseline level of occurrence, perform one or more actions that mitigate or eliminate the malware threats. Once trained, the AI algorithms, are executed to monitor for the behaviors and/or pattern of behaviors, and, in response to detecting the behaviors or pattern of behaviors and determining that the behavior level exceeds an acceptable baseline level of occurrence, one or more actions are triggered to mitigate (i.e., prohibit further propagation of the malware within the computing network) or eliminate (i.e., stop the malware from detonating within the computing system) the threat posed by the malware.

In specific embodiments of the invention, the actions that are triggered (e.g., communication of alerts, isolation of computing systems, or the like) are determined by the AI/ML, dynamically (i.e., on-the-fly) based on rules that take into account the attributes of the behaviors (type of behaviors, volume of behaviors, timing of behaviors and the like).

Moreover, in additional embodiments of the invention, AI algorithms are trained not only to detect behaviors and/or patterns of behaviors but also other known or future known indicators (e.g., digital signatures or the like), which indicate the presence of malware in the system. In such embodiments of the invention, the actions that are triggered by the AI algorithms are not only in response to detection of behaviors but also in response to detection of indicators, such as digital signatures or the like.

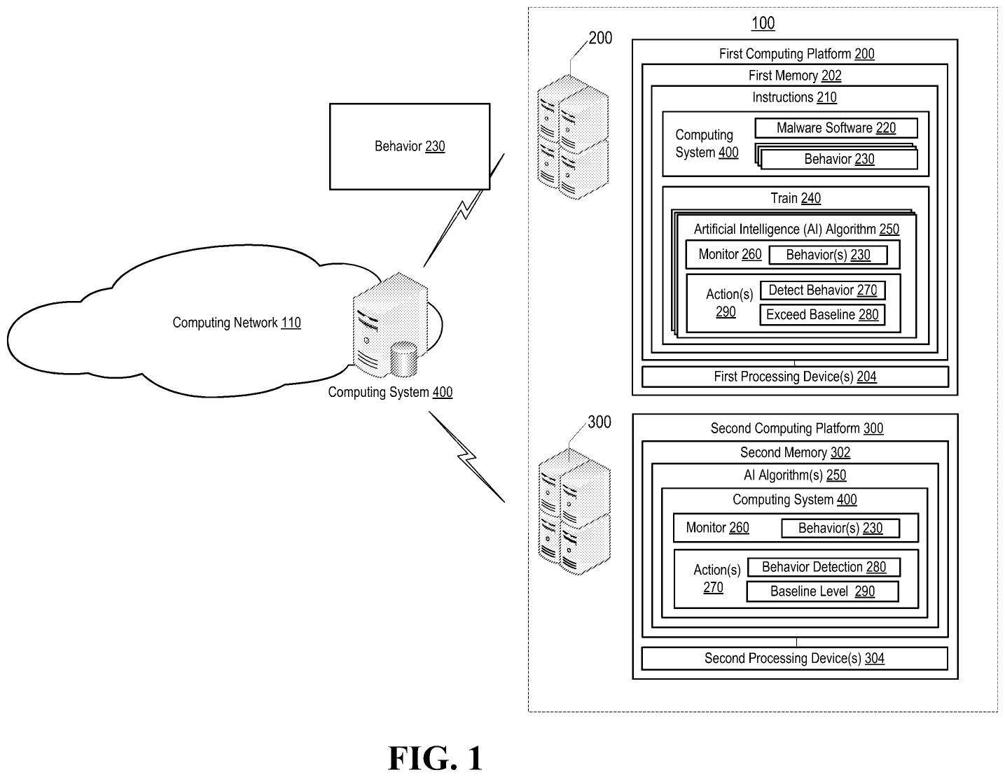

Referring to FIG. 1 a schematic diagram is presented of an exemplary system 100 for AI detection of malware threats based on behaviors of the computing system in the presence of malware software, in accordance with embodiments of the present invention. As depicted, the system 100 includes a first computing platform 200 and a second computer platform 300. However, one of ordinary skill in the art will appreciate that the functionality described herein as being performed within first computing platform 200 may be performed within second computing platform 300 or additional computing platforms and/or the functionality described herein as being performed within second computing platform 300 may be performed within first computing platform 200 or additional computing platforms. As such, the system 100 may include one solitary computing platform, or, in other embodiments, computing platforms in addition to first computing platform 200 and second computing platform 300.

First computing platform 200 includes a first memory 202 and one or more first processing devices 204 in communication with the first memory 202. The first memory stores instructions 210 that are executable by the first processing device(s) 204. The first instructions are configured to determine/observe one or more behaviors 230 of a computing system 400 while it is in the presence of malware software 220, which, in specific embodiments of the invention, may be ransomware software. The computing system 400, which may comprise one or multiple computing devices, is part of computing network 110, which typically comprises multiple other computing systems. As used herein, the “behaviors” refers to any computing system event/activity or computing system configuration that occurs in the presence of malware/ransomware software (i.e., after the malware has penetrated the perimeter of the computing system). In those embodiments of the method, in which the malware software 220 is ransomware software, the behaviors 220 may be any computing system event or configuration that occurs prior to encryption of files. In specific embodiments of the system, the behaviors 220 are determined/observed via implementation of AI and, specifically ML techniques.

The instructions 210 are further configured to train, over time, one or more AI algorithms 250 to monitor 260 for the determined behaviors 230. Further the instructions are configured to train, over time, the AI algorithm(s) to determine one or more actions 270 to take specific to the determined behaviors 230 in response to behavior detection 230 and determining that an acceptable baseline level 290 has been exceeded for the behavior 230 and initiate the occurrence of the one or more actions 270. The actions 270 are taken to mitigate (limit further propagation of the malware beyond the computing system) or prevent (stop the malware from detonating within the computing system) the threat posed by the malware/ransomware software. The acceptable baseline level 290 is the normal amount that the computing system experiences absent the presence of the malware software 220 and/or or the normal configuration of the system 400 absent the malware software 220. The acceptable baseline levels 290 for each behavior may be predetermined or may dynamically change based on known threats or changes in utilization of the computing system and/or network. The actions that occur may include, but are not limited to, initiating communication of alerts, isolating the computing system (i.e., one or more computing devices) from the network, reconfiguring the computing system, shutting down the computing system and the like.

System 100 additionally includes second computing platform 300 having a second memory 302 and one or more second processing devices 304 in communication with the second memory 302. The second memory 302 stores trained AL algorithms 250, which are executable by the second processing device(s) 304. The AI algorithm(s) 250 are configured to monitor 260 for the occurrence of the one or more behaviors 230 within computing system 400. The AI algorithms 250 are further configured to implement AI/ML to determine one or more actions 270 in response to behavior detection 280 and determining that an acceptable baseline level 290 has been exceeded for the behavior 230 and initiate the occurrence of the one or more actions 270

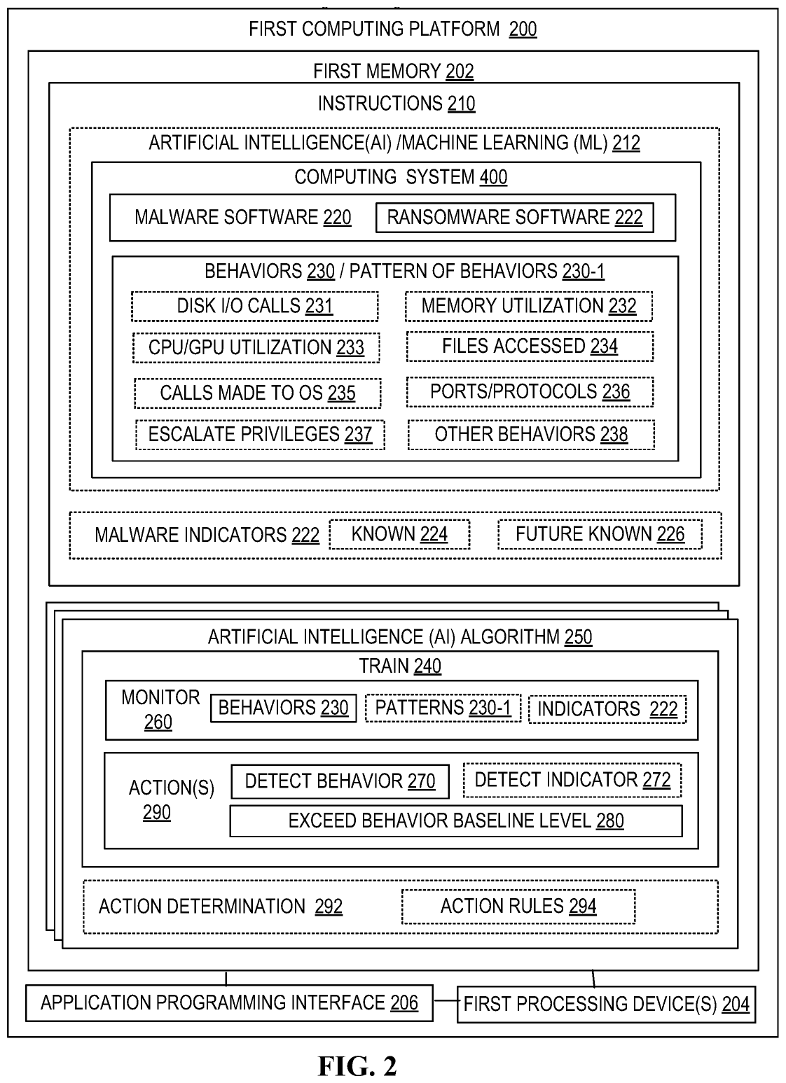

Referring to FIG. 2, a block diagram is depicted of first computing platform 200, in accordance with embodiments of the present invention. In addition to providing greater detail, FIG. 2 highlights various alternate embodiments of the system 200. First computing platform 200 comprises one or more computing devices/apparatus, such as application server(s), storage servers or the like configured to execute software programs, including instructions, engines, algorithms, modules, routines, applications, tools, and the like. First computing platform 200 includes first memory 202, which may comprise volatile and non-volatile memory, such as read-only and/or random-access memory (RAM and ROM), EPROM, EEPROM, flash cards, or any memory common to computer platforms). Moreover, first memory 202 may comprise cloud storage, such as provided by a cloud storage service and/or a cloud connection service.

Further, first computing platform 200 also includes first processing device(s) 204, which may be an application-specific integrated circuit (“ASIC”), or other chipset, logic circuit, or other data processing device. First processing device 204 may execute an application programming interface (“API”) 206 that interfaces with any resident programs, such as instructions 210 and sub-engines/routines associated therewith or the like stored in the first memory 202 of the first computing platform 200.

First processing device 204 may include various processing subsystems (not shown in FIG. 2) embodied in hardware, firmware, software, and combinations thereof, that enable the functionality of first computing platform 200 and the operability of first computing platform 200 on a distributed communication network. For example, processing subsystems allow for initiating and maintaining communications and exchanging data with other networked devices. For the disclosed aspects, processing subsystems of first processing device 204 may include any subsystem used in conjunction with instructions 210 and related sub-engines/routines, algorithms, sub-algorithms, modules, sub-modules thereof.

First computing platform 200 additionally includes a communications module (not shown in FIG. 2) embodied in hardware, firmware, software, and combinations thereof, that enables electronic communications between first computing platform 200 and other networks and/or networked devices, such as, second computing platform 300 and computing system 400. Thus, the communication module may include the requisite hardware, firmware, software and/or combinations thereof for establishing and maintaining a network communication connection with one or more systems, platforms, networks, or the like.

As previously discussed in relation to FIG. 1, first memory 202 of computing platform 200 stores instructions 210 that are configured to observe/determine one or more behaviors 230 within a computing system 400 that occur in the presence of malware software 220 and, in specific embodiments of the invention, ransomware software 222. The behaviors 230 may be any computing system event or computing system configuration that occurs in the presence of malware/ransomware software 220, 222 (i.e., after the malware/ransomware 220, 222 has penetrated the periphery of the computing system 400). In those embodiments of the system, in which the malware 220 is ransomware 222, the behaviors may be any computing system event or configuration that occurs prior to encryption of files.

In specific embodiments of the method, the behaviors are determined/observed via implementation of AI and, specifically ML techniques 221. In further specific embodiments of the method, the behaviors are determined/observed as a result of an actual malware attack occurring at the computing system 400. While in other embodiments of the method, the behaviors may be determined/observed based on a simulated malware attack occurring within a test computing system environment or the like.

The behaviors 230 that are determined/observed may include, but are not limited to, (i) specific disk input/output calls 231, (ii) memory utilization 232, (iii) processing unit (i.e., central and or graphical) utilization 233, (iv) files accessed 234, (v) types/volume of calls made to operating system 235, (vi) ports and protocols 236 used for calls, (vii) attempts to escalate access privileges 237 and other behaviors (i.e., other computing system events and/or computing system configurations).

In specific embodiments of the system, the behaviors 230 that are observed/determined, typically via implementation of AI/ML 212, are patterns of behaviors 230-1. A pattern of behaviors 230-1 as used herein comprises two or more behaviors 230 that occur either in parallel or in sequence. In addition, the pattern of behaviors may have additional parameters that define requirements for detecting the pattern, such as timing requirements, order of behaviors and the like.

In other embodiments of the system, the behaviors are analyzed, using ML techniques, to determine the impact from changes to the computing system on the behaviors. The changes may include, but are not limited to, (i) hardware and/or software configuration within the computing system, (ii) service packs installed on the computing system, (iii) operating system revisions and the like.

In response to determining/observing the behaviors 230, the instructions 210 are configured to train 240, one or more AI algorithm(s) 250 to (i) monitor 260 for the occurrence of the behaviors 230 or patterns of behaviors 230-1, and (ii) in response to detecting the occurrence of the behavior 230 or pattern of behaviors 230-1 and determining that the occurrence exceeds an acceptable baseline level 280 for the behavior 230 or pattern of behaviors 230-1, determine one or more actions 290 specific to the behaviors and the amount by which the baseline level 280 is exceeded and initiate the occurrence of the one or more actions 290 to mitigate (limit further propagation of the malware beyond the computing system) or prevent (stop the malware from detonating within the computing system) the threat posed by the malware/ransomware software. Acceptable baseline levels 280 may be predetermined for the computing system 400 or may be dynamically assigned based on current malware threat levels or current utilization of the computing system/network.

The actions 290 that occur may include, but are not limited to, initiating communication of alerts, isolating the computing system from the network, reconfiguring the computing system, shutting down the computing system and the like. In specific embodiments of the invention, the instructions 210 may be configured for action determination 292, in which the actions 290 are determined based on action rules 294 applicable to the behaviors 230. Specifically, the action rules 294 may dictate which actions 290 occur based on the behavior 230 or pattern of behaviors 230-1 observed and, in some embodiments, attributes of the behavior 230, e.g., timing of the behavior 230, volume of the behavior 230, type of behavior 230, timing between behaviors 230 in a pattern of behaviors 230-1, sequence of behaviors 230 in a pattern of behavior 230-1 or the like.

In other embodiments of the system 100, the AI algorithms 250 are additionally trained with malware indications 222, including known/existing indicators 224 (e.g., digital signatures) or future known/new emerging indicators 226 (i.e., industry identified indicators), which indicate the presence of malware. In such embodiments of the system, the action(s) 290 may be initiated in response to detection of behavior(s) 230 and one or more indicators 222.

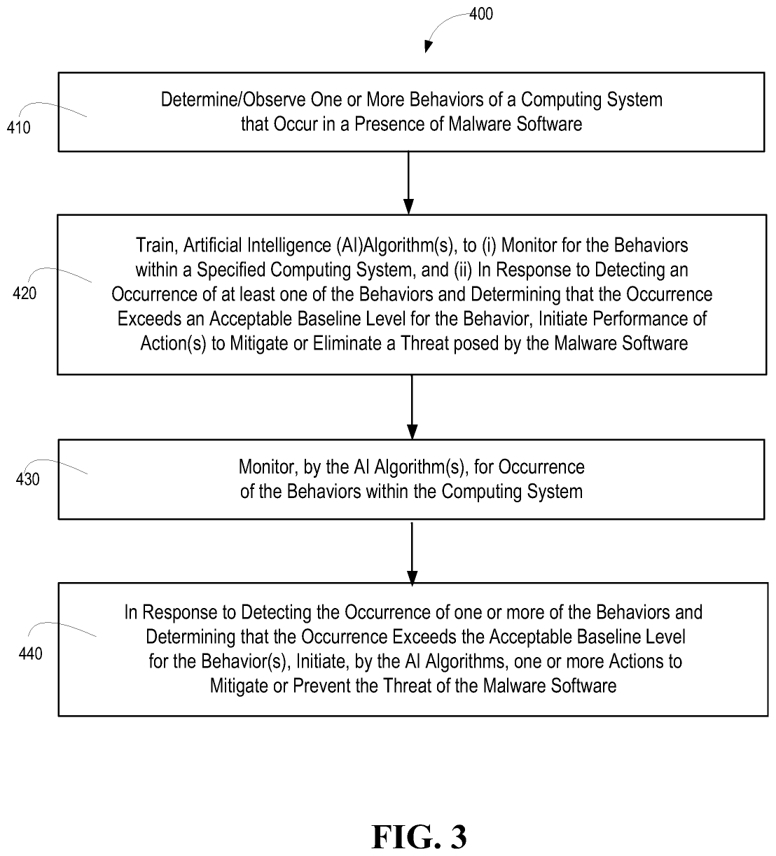

Referring to FIG. 3, a flow diagram is depicted of a method 400 for AI detection and prevention of malware threats based on behaviors of the computing system in the presence of malware software, in accordance with embodiments of the present invention. In specific embodiments the method 400 is operating system-agnostic, meaning that it can be implemented on a computing system executing any known or future known operating system. At Event 410, one or more behaviors are observed/determined within a computing system that occur in the presence of malware software and, in specific embodiments of the invention, ransomware software. The behaviors may be any computing system event or computing system configuration that occurs in the presence of malware/ransomware software (i.e., after the malware has penetrated the periphery of the computing system). In those embodiments of the method, in which the malware is ransomware, the behaviors may be any computing system event or configuration that occurs prior to encryption of files.

In specific embodiments of the method, the behaviors are determined/observed via implementation of AI and, specifically ML techniques. In further specific embodiments of the method, the behaviors are determined/observed as a result of an actual malware attack occurring at the computing system. While in other embodiments of the method, the behaviors may be determined/observed based on a simulated malware attack occurring within a test computing system environment or the like.

The behaviors that are determined/observed may include, but are not limited to, (i) specific disk input/output calls, (ii) memory utilization, (iii) processing unit (i.e., central and or graphical) utilization, (iv) files accessed, (v) types of calls made to operating system, (vi) ports and protocols used for calls, (vii) attempts to escalate access privileges and the like.

In specific embodiments of the method, the behaviors that are observed/determined, typically via implementation of AI/ML, are patterns of behaviors. A pattern of behavior as used herein comprises two or more behaviors that occur either in parallel or in sequence. In addition, the pattern of behaviors may have additional parameters that define requirements for detecting the pattern, such as timing requirements, order of behaviors and the like.

In other embodiments of the method, the behaviors are analyzed, using ML techniques, to determine the impact from changes to the computing system on the behaviors. The changes may include, but are not limited to, (i) hardware and/or software configuration within the computing system, (ii) service packs installed on the computing system, (iii) operating system revisions and the like.

In response to determining/observing the behaviors, at Event 420, AI algorithm(s) are trained, over time, to (i) monitor for the occurrence of the behaviors or patterns of behaviors, and (ii) in response to detecting the occurrence of the behavior or pattern of behaviors and determining that the occurrence exceeds an acceptable baseline level for the behavior, initiate one or more actions to mitigate (limit further propagation of the malware beyond the computing system) or prevent (stop the malware from detonating within the computing system) the threat posed by the malware/ransomware software. Acceptable baseline levels may be predetermined for the computing system.

The actions that occur may include, but are not limited to, initiating communication of alerts, isolating the computing system from the network, reconfiguring the computing system, shutting down the computing system and the like. In specific embodiments of the invention, the actions may be determined based on rules applicable to the behaviors. Specifically, the rules may dictate which actions occur based on the behavior or pattern of behaviors observed and, in some embodiments, attributes of the behavior, e.g., timing of the behavior, volume of the behavior, type of behavior, timing between behaviors in a pattern of behaviors, sequence of behaviors in a pattern of behavior or the like.

In other embodiments of the invention, the AI algorithms are additionally trained with existing indicators (e.g., digital signatures) or new emerging indicators (i.e., industry identified indicators), which indicate the presence of malware. In such embodiments of the method, the action(s) may be initiated in response to detection of behavior(s) and one or more indicators.

Once trained, at Event 430, the AI algorithm(s) are executed and monitoring for the occurrence of behaviors of patterns of behaviors commences. At Event 440, in response in response to detecting the occurrence of the behavior or pattern of behaviors and determining that the occurrence exceeds an acceptable baseline level for the behavior, initiate one or more actions to mitigate or prevent the threat posed by the malware/ransomware software.

Thus, present embodiments of the invention provide systems, methods, computer program products and/or the like for Artificial Intelligence (AI) detection of malware, and, specifically, ransomware, based on behaviors that occur in the computing system in the presence of the malware. In this regard, according to the present invention, malware detection is not based on, or in some embodiments is not limited to, detection of indicators (e.g., digital signatures or the like) that indicate the presence of malware. The invention observes/determines behavior or patterns or behaviors that occur in the computing system in the presence of malware and, in response, trains the AI to monitor for such behaviors and, in response to detecting a behavior(s) and determining that the occurrence exceeds a baseline level of occurrence, the AI initiate performance of one or more actions to mitigate or eliminate the malware threat.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for detection and prevention of threats posed by malware software on computing system, the system comprising:
a first computing platform including a first memory and one or more first processing devices in communication with the first memory, wherein the first memory stores instructions that are executable by the one or more first processing devices and configured to:
determine one or more behaviors of a computing system that occur in a presence of malware software,
train, one or more Artificial Intelligence (AI) algorithms, to (i) monitor for the behaviors within a specified computing system, and (ii) in response to detecting at least one of the one or more behaviors and determining that the at least one of the one or more behaviors exceeds an acceptable baseline level for the at least one of the one or more behaviors, perform one or more actions to mitigate or eliminate a threat posed by the malware software; and
a second computing platform including a second memory and one or more second processing devices in communication with the first memory, wherein the second memory stores the trained one or more AI algorithms that are executable by the one or more processing devices and configured to:
monitor for the behaviors within the specified computing system, and
in response to detecting at least one of the one or more behaviors and determining that the at least one of the one or more behaviors exceeds the acceptable baseline level for the at least one of the one or more behaviors, perform one or more actions to mitigate or eliminate the threat posed by the malware software.

2. The system of claim 1, wherein the system is operating system-agnostic.

3. The system of claim 1, wherein the malware software is further defined as ransomware software.

4. The system of claim 3, wherein the instructions configured to determine the one or more behaviors of the computing system that occur in the presence of the malware software, further defines the behaviors as events or configurations that occur in preparation for self-encryption of files.

5. The system of claim 1, wherein the instructions configured to determine the one or more behaviors of the computing system that occur in the presence of malware software, further defines the behaviors as one or more of (i) disk input/output calls, (ii) memory utilization, (iii) processing unit utilization, (iv) files accessed, (v) types of calls made to operating system, (vi) ports and protocols used for calls, (vii) attempts to escalate access privileges.

6. The system of claim 1, wherein the instructions configured to determine the one or more behaviors of the computing system that occur in the presence of the malware software are further configured to determine a pattern of behaviors that occur in the presence of the malware software and instructions configured to train, the AI algorithms, to monitor for the behaviors are further configured to train, the one or more AI algorithms, to monitor for the pattern of behaviors.

7. The system of claim 1, wherein the instructions configured to determine the one or more behaviors of the computing system that occur in the presence of the malware software are further configured to determine, implementing Artificial Intelligence (AI) and Machine Learning (ML), the one or more behaviors of the computing system that occur in the presence of the malware software.

8. The system of claim 1, wherein the AI algorithms are further configured to determine the one or more actions by applying action rules to the detected behaviors.

9. The system of claim 1, wherein the first instructions are further configured to train, the one or more AI algorithms, to further monitor for one or more predetermined indicators that indicate the presence of the malware software and wherein the one or more actions are configured to be performed in further response to detection of at least one of the one or more predetermined indicators.

10. The system of claim 1, wherein the instructions configured to determine one or more behaviors of a computing system that occur in a presence of malware software are further configured to analyze, using Machine Learning (ML), the one or more behaviors based on changes to at least one of (i) hardware and/or software configuration within the computing system, (ii) service packs installed on the computing system, and (iii) operating system revisions.

11. A computer-implemented method for detection and prevention of threats posed by malware software on computing system, the computer-implemented method is executable by one or more computing processor devices, the method comprising:
determining one or more behaviors of a computing system that occur in a presence of malware software;
training, one or more Artificial Intelligence (AI) algorithms, to (i) monitor for the behaviors within a specified computing system, and (ii) in response to detecting at least one of the one or more behaviors and determining that the at least one of the one or more behaviors exceeds an acceptable baseline level for the at least one of the one or more behaviors, perform one or more actions to mitigate or eliminate a threat posed by the malware software; and
monitoring, by the one or more AL algorithms, for the behaviors within the specified computing system, and
in response to detecting at least one of the one or more behaviors and determining that the at least one of the one or more behaviors exceeds the acceptable baseline level for the at least one of the one or more behaviors, performing, by the one or more AI algorithms, one or more actions to mitigate or eliminate the threat posed by the malware software.

12. The computer-implemented method of claim 11, wherein the method is operating system-agnostic.

13. The computer-implemented method of claim 11, wherein the malware software is further defined as ransomware software and wherein determining the one or more behaviors of the computing system that occur in the presence of the malware software, further defines the behaviors as computing events or configurations that occur in preparation for self-encryption of files.

14. The computer-implemented method of claim 11, wherein determining the one or more behaviors of the computing system that occur in the presence of malware software, further defines the behaviors as one or more of (i) disk input/output calls, (ii) memory utilization, (iii) processing unit utilization, (iv) files accessed, (v) types of calls made to operating system, (vi) ports and protocols used for calls, and (vii) attempts to escalate access privileges.

15. The computer-implemented method of claim 11, wherein determining the one or more behaviors of the computing system that occur in the presence of the malware software are further include determining a pattern of behaviors that occur in the presence of the malware software and training, the one or more AI algorithms, to monitor for the behaviors further includes training, the one or more AI algorithms, to monitor for the pattern of behaviors.

16. A computer program product comprising:
a non-transitory computer-readable medium comprising:
a first set of codes for causing a computer to determine one or more behaviors of a computing system that occur in a presence of malware software;
a second set of codes for causing a computer to train, one or more Artificial Intelligence (AI) algorithms, to (i) monitor for the behaviors within a specified computing system, and (ii) in response to detecting at least one of the one or more behaviors and determining that the at least one of the one or more behaviors exceeds an acceptable baseline level for the at least one of the one or more behaviors, perform one or more actions to mitigate or eliminate a threat posed by the malware software; and
a third set of codes for causing a computer to monitor, by the one or more AL algorithms, for the behaviors within the specified computing system, and
a fourth set of codes for causing a computer to, in response to detecting at least one of the one or more behaviors and determining that the at least one of the one or more behaviors exceeds the acceptable baseline level for the at least one of the one or more behaviors, perform, by the one or more AI algorithms, one or more actions to mitigate or eliminate the threat posed by the malware software.

17. The computer program product of claim 16, wherein the sets of codes are operating system-agnostic.

18. The computer program product of claim 16, wherein the malware software is further defined as ransomware software and wherein the first set of codes is further configured to cause the computer to determine the one or more behaviors of the computing system that occur in the presence of the malware software, wherein the one or more behaviors are defined as computing events or configurations that occur in preparation for self-encryption of files.

19. The computer program product of claim 16, wherein the first set of codes is further configured to cause the computer to determine the one or more behaviors of the computing system that occur in the presence of malware software, wherein the one or more behaviors are further defined as one or more of (i) disk input/output calls, (ii) memory utilization, (iii) processing unit utilization, (iv) files accessed, (v) types set of codes of calls made to operating system, (vi) ports and protocols used for calls, (vii) attempts to escalate access privileges.

20. The computer program product of claim 19, wherein the first set of codes is further configured to cause the computer to determine a pattern of behaviors that occur in the presence of the malware software and the second set of codes are further configured to cause the computer to train, the one or more AI algorithms, to monitor for the pattern of behaviors.
